(19) United States
(12) Patent Application Publication
(10) Pub. No.: US 2026/0225586 A1
(43) Pub. Date: Aug. 6, 2026

(54) AUTOMATED AND AUTONOMOUS TRIGGER MANAGEMENT BASED ON TRIGGER CRITICALITY AND FUNCTIONAL SCENARIOS

(71) Applicant: PlusAI, Inc., Santa Clara, CA (US)

(72) Inventors: Mingyan Zhou, Santa Clara, CA (US); Robert Joseph Dingli, Cupertino, CA (US); Chao Wang, McLean, VA (US)

(21) Appl. No.: 19/042,381

(22) Filed: Jan. 31, 2025

(51) Int. Cl. B60W 30/09; B60W 30/18; B60W 50/00

(52) U.S. Cl. CPC B60W 30/09; B60W 30/18163; B60W 50/0098; B60W 2552/10

(57) ABSTRACT

Methods, systems, and non-transitory computer readable media are configured to perform operations comprising determining, by a computing system, a trigger event associated with a vehicle based on occurrence of a trigger condition associated with degradation of a feature relating to vehicle operation; determining, by the computing system, a trigger criticality associated with the trigger event; and selecting, by the computing system, a minimal risk maneuver (MRM) from a plurality of MRMs based on the trigger criticality, the MRM executable based on scenario conditions.

### FIELD OF THE INVENTION

The present technology relates to vehicle systems. More particularly, the present technology relates to trigger management of vehicles having automated or autonomous modes of navigation.

### BACKGROUND

Vehicles can be operated at various levels of autonomy or assistance. The levels can span a range from modest driver assistance to fully automated navigation. Operation of vehicles at these levels is subject to various safety requirements. A vehicle can be required to activate a safety mechanism when a vehicle experiences a significant failure or encounters a situation that cannot be handled safely.

### SUMMARY

Various embodiments of the present technology can include methods, systems, and non-transitory computer readable media configured to perform operations comprising determining, by a computing system, a trigger event associated with a vehicle based on occurrence of a trigger condition associated with degradation of a feature relating to vehicle operation; determining, by the computing system, a trigger criticality associated with the trigger event; and selecting, by the computing system, a minimal risk maneuver (MRM) from a plurality of MRMs based on the trigger criticality, the MRM executable based on scenario conditions.

In some embodiments, the trigger condition relates to base capabilities of the vehicle.

In some embodiments, the trigger condition relates to capabilities of the vehicle provided by an advanced driving system (ADS).

In some embodiments, the trigger condition relates to at least one of an environment and operational design domain (ODD) of the vehicle, offboard infrastructure, or a state of a driver of the vehicle.

In some embodiments, the feature relating to vehicle operation is from a plurality of features relating to vehicle operation including longitudinal control and lateral control.

In some embodiments, the feature relating to vehicle operation is associated with a status indicating a level of degradation from a predetermined number of levels.

In some embodiments, the trigger criticality is associated with a level from a plurality of levels indicating severity of the trigger event.

In some embodiments, the MRM is associated with a functional scenario built from a plurality of atomic maneuvers including stop on shoulder, stop in driving lane, pull over, ALC towards outer driving lane, and slow down to desired speed.

In some embodiments, the functional scenario is from a set of functional scenarios associated with initial vehicle travel in an outer lane or a set of functional scenarios associated with initial vehicle travel not in the outer lane.

In some embodiments, the plurality of MRMs include pull over to shoulder (POTS), stop in lane (SIL), and pull to off-ramp shoulder (PTORS), and the vehicle is associated with an L2+, L2++, L3, or L4 level of autonomy.

It should be appreciated that many other embodiments, features, applications, and variations of the present technology will be apparent from the following detailed description and from the accompanying drawings. Additional and alternative implementations of the methods, non-transitory computer readable media, systems, and structures described herein can be employed without departing from the principles of the present technology.

### BRIEF DESCRIPTION OF THE DRAWINGS

FIG. 1 illustrates a simplified functional block diagram of an example fault management system, according to embodiments of the present technology.

FIGS. 2A-2E illustrate example atomic maneuvers, according to embodiments of the present technology.

FIGS. 3A-3C illustrate example functional scenarios associated with no automatic lane change (ALC), according to embodiments of the present technology.

FIGS. 4A-4C illustrate example functional scenarios associated with automatic lane change (ALC), according to embodiments of the present technology.

FIG. 5 illustrates example decision logic for a fault management system, according to embodiments of the present technology.

FIG. 6 illustrates an example method, according to embodiments of the present technology.

FIG. 7 illustrates an example vehicle, according to embodiments of the present technology.

FIG. 8 illustrates an example computing system, according to embodiments of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Vehicles can be operated at various levels of autonomy or assistance. The levels can span a range from modest driver assistance to fully automated navigation. Operation of vehicles at these levels is subject to various safety requirements. A vehicle can be required to activate a safety mechanism when a vehicle experiences a significant failure or encounters a situation that cannot be handled safely.

A minimum risk maneuver (MRM) associated with a vehicle is a safety-critical feature associated with certain levels of operational autonomy or assistance, such as L2+ to L4. The objective of an MRM is to bring a vehicle to a safe, stable state with minimal risk to vehicle occupants and other road users. A variety of trigger events can cause the performance of an MRM. In response to a trigger event, a navigation system of the vehicle can perform a safe behavior, such as a “stop in lane” (SIL). SIL can refer to longitudinal decelerated motion for a vehicle to stop in the lane in which the vehicle is travelling. SIL can be a simple, effective safe behavior to perform in many situations.

However, sole use of SIL is not optimal in all situations and fails to account for variability in different trigger events and variability across different scenarios. For example, if a vehicle should perform an immediate lane change to avoid an approaching obstacle, SIL may not be the most appropriate response because of the possibility of impact with the obstacle. As another example, if a roadway is characterized by other high-speed vehicles in low visibility conditions, SIL may not be the most appropriate response because SIL would leave the vehicle vulnerable to collisions with the other vehicles. Thus, the availability and performance of additional MRMs apart from SIL can be more appropriate in various situations. As the autonomy level of vehicles increases, the activation of more complex MRMs in appropriate situations can increase vehicle performance and optimize vehicle safety.

The present technology provides improved approaches for vehicle navigation that overcome the aforementioned and other technological disadvantages. In various embodiments, the present technology can utilize a fault management system for a vehicle that can perform a variety of optimal MRMs in response to a wide array of trigger events and scenarios. For example, the MRMs can include “pull over to shoulder” (POTS), which can refer to a lane change by a vehicle from an outer driving lane to a shoulder in the lateral direction while the vehicle slows down to stop in the longitudinal direction. As another example, the MRMs can include “pull to off-ramp shoulder” (PTORS), which can refer to a vehicle pulling over to an off-ramp shoulder zone, or driving off a highway and conducting POTS. Additional MRMs can be defined and utilized. Functional scenarios can formulate the external environment for developing various MRM with clear setup and provide a visualized, straightforward understanding of navigation problems to be solved. Usage of atomic behaviors can break down complexities of an MRM into finite unitary behavior and facilitate build up and extension of the atomic behaviors.

The selection of a particular MRM to be performed by a vehicle can be based on a trigger condition, vehicle capability, and scenario encountered by the vehicle. A trigger condition can refer to a basis or reason for initiating an MRM. A trigger condition can be based on a trigger condition associated with vehicle, environmental factors, offboard commands, and driver interaction when a human driver is presented in the vehicle. Vehicle capability can refer to degradation of the functional robustness (and redundancy) of the vehicle due to a vehicle-related trigger condition. Based on these considerations, a level of trigger criticality can be determined from predetermined levels of trigger criticality. The predetermined levels of trigger criticality can advantageously categorize hundreds or even thousands of different trigger events into a finite number of inputs to consider. The selection of MRMs then can be designed based on these levels of trigger criticality with more organized structure and easier traceability. A scenario can refer to a combination of, for example, environmental conditions (e.g., extreme weather leading to degradation in perception quality), road topography, surrounding traffic, and the existence of safe places to stop the vehicle. Selection of an optimal MRM can be based on the foregoing and other considerations. The present invention can allow for the design and implementation of a robust fault management systems that can meet and exceed the requirements of future industry safety standards (e.g., ISO standards). These and other inventive features and related advantages of the various embodiments of the present technology are discussed in more detail herein.

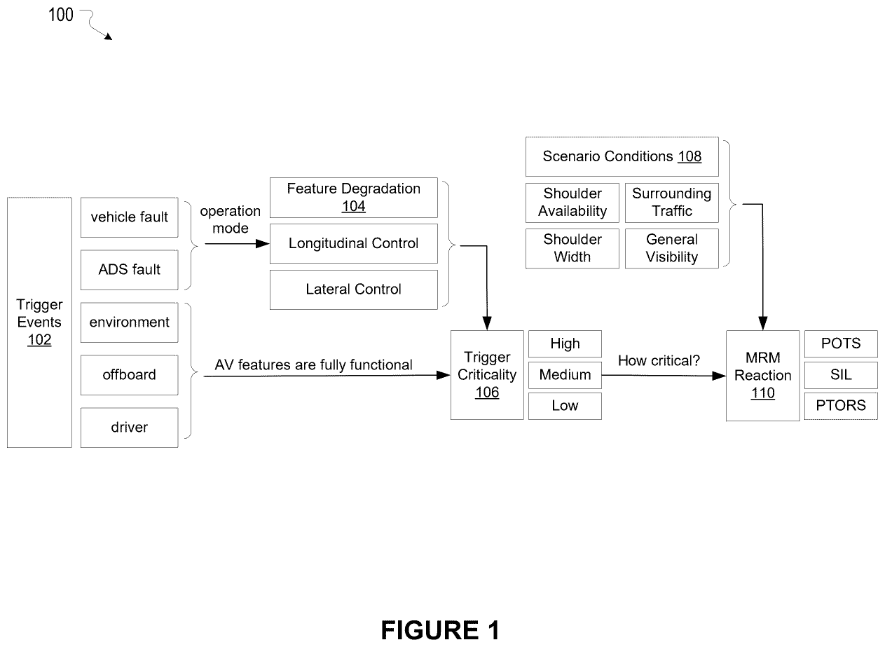

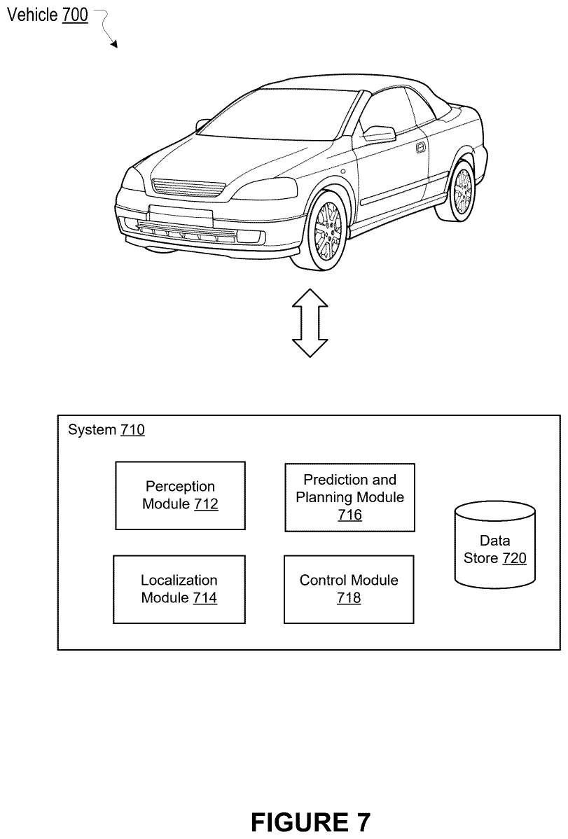

FIG. 1 illustrates a simplified functional block diagram of an example fault management system (or subsystem) 100, according to some embodiments of the present technology. In some embodiments, the fault management system 100 can be a subsystem or portion of an overall navigation system of vehicles (or subject vehicles) having various levels of automation or autonomy. The fault management system 100 can be implemented in vehicles having, for example, L2+ to L4 (e.g., L2+, L2++, L3, L4, etc.) capabilities. In response to a trigger event 102 (or fault), the fault management system 100 can select an optimal MRM to be performed by a vehicle based on a variety of considerations. As discussed in more detail herein, the selection of an optimal MRM can be based on the nature of a trigger event 102 associated with a trigger, potential feature degradation associated with vehicle capabilities, a level of trigger criticality, and scenario conditions. The fault management system 100 can be appropriately implemented across various systems and subsystems of a vehicle, such as a perception module 712, a localization module 714, a prediction and planning module 716, and a control module 718 of a system 710 of FIG. 7, as discussion in more detail herein.

In some embodiments, some or all of the functionality performed by the fault management system 100 may be performed by one or more computing systems implemented in a vehicle. In some embodiments, some or all of the functionality performed by the fault management system 100 may be performed by one or more backend or cloud computing systems remote from the vehicle. In some embodiments, some or all data processed and/or stored by the fault management system 100 can be stored in a data store (e.g., local to the fault management system 100) or other storage system (e.g., cloud storage remote from the fault management system 100). The components (e.g., modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the fault management system 100 can be implemented in or performed by any suitable combinations of the fault management system 100.

The fault management system 100 can determine the existence of trigger events 102. The trigger events 102 can relate to occurrence of trigger conditions that potentially impact vehicle safety and thus warrant performance of an MRM. A trigger event 102 can be associated with various types or categories of trigger conditions. In some embodiments, the types of trigger conditions can be related to vehicle capabilities and non-vehicle capabilities. For example, a type of trigger condition relating to vehicle capabilities can be trigger conditions relating to base capabilities of a base vehicle. This type of trigger condition can include, for example, a depleted brake pad, unresponsive throttle, a flat tire, a non-functional blinker, and the like.

As another example, another type of trigger condition relating to vehicle capabilities can be trigger conditions relating to capabilities of a vehicle provided by an advanced driving system (ADS) implemented on the vehicle. The ADS can include, for example, sensors (e.g., cameras, LiDAR, radar, etc.), software, and computing hardware added to a base vehicle so that the vehicle can operate at a desired level of autonomy. This type of trigger condition can include, for example, an out-of-sync sensor, sensor signal shutdown, calculation failure, software bug, topic loss, data instability, and the like.

Types of trigger conditions relating to non-vehicle capabilities can occur whether or not a trigger condition relating to vehicle capabilities has occurred. For example, a type of trigger condition relating to non-vehicle capabilities can be trigger conditions relating to an environment in which a vehicle is located and implicating the operational design domain (ODD) of the vehicle. This type of trigger condition can include a predictable component and an unpredictable component. The predictable component of this type of trigger condition can be associated with identifiable or detectable environmental events or conditions, such as heavy rain limiting sensor visibility, minimal road friction causing tire slippage, hazard cones indicating a road obstruction, and the like. The unpredictable component of this type of trigger condition can be associated with environmental events or conditions that are not identifiable or detectable, such as unfamiliar obstacles or scenarios that a perception system of the vehicle has not been trained to detect.

As another example, another type of trigger condition relating to non-vehicle capabilities can be trigger conditions relating to offboard infrastructure or a related control center. The control center can be remote from a vehicle and conduct communications with the vehicle to exchange information to inform navigation of the vehicle. This type of trigger condition can involve provision by the control center of a suggestion, command, or other information to the vehicle potentially warranting performance of an MRM. For example, the information provided by the control center to the vehicle can be descriptive of or associated with an event or condition that is not or cannot be perceived by the vehicle.

As another example, another type of trigger condition relating to non-vehicle capabilities can be trigger conditions relating to a state or condition of a driver of the vehicle, when a driver is present in the vehicle. The presence of a driver can be associated with L2, L2+, and L2++ levels of autonomy. This type of trigger condition can be associated with insufficient attention or other improper behavior of the driver. For example, the improper behavior can include hands off the steering wheel, eyes directed away from system monitoring, and the like.

The foregoing types or categories of trigger conditions are only some examples. In other embodiments, other types of trigger conditions are possible.

The types of trigger conditions relating to vehicle capabilities potentially can result in feature degradation 104 as determined by the fault management system 100. Feature degradation 104 can refer to degradation of features relating to vehicle operation. The features relating to vehicle operation can be associated with particular capabilities of a vehicle. For example, the features relating to vehicle operation can include longitudinal control and lateral control. Longitudinal control features can refer to, for example, lane-following including basic lane centering and stay in lane maneuvers. Lateral control features can refer to, for example, nudge and lane change. As other examples, the features relating to vehicle operation can include adaptive cruise control (ACC), automatic emergency braking (AEB), autonomous parking, lane keeping assist (LKA), blind spot monitoring (BSM), pedestrian detection, and the like. The foregoing are examples, and other features relating to vehicle operation are possible. When types of trigger conditions relating to vehicle capabilities are detected, the features relating to vehicle operation can be degraded to varying degrees of severity. The status of the features relating to vehicle operation that are degraded can be determined and indicated at various predetermined levels. For example, the predetermined levels of feature degradation can be indicated as nominal, limited, not available, or other levels of severity.

The fault management system 100 can associate a trigger event 102 with one or more trigger conditions. For example, a trigger event 102 can be associated with detection of a trigger condition associated with one type of trigger condition. As another example, a trigger event 102 can be associated with detection of a plurality of trigger conditions associated with one type of trigger condition. As yet another example, a trigger event 102 can be associated with detection of a first plurality of trigger conditions associated with a first type of trigger condition and a second plurality of trigger conditions associated with a second type of trigger condition. As a further example, a trigger event 102 can be associated with a plurality of trigger conditions including trigger conditions relating to vehicle capabilities. In this example, the trigger conditions relating to vehicle capabilities can be associated with a plurality of features relating to vehicle operation that are degraded along with status of the features. In some instances, a table can be generated that reflects the features and their status.

A trigger criticality 106 can be determined by the fault management system 100 for a trigger event 102. Trigger criticality 106 can indicate the severity or level or risk associated with a trigger event. Trigger criticality 106 can be determined for a trigger event 102 based on associated trigger conditions and, as applicable, the features relating to vehicle operation that are degraded and their status. Trigger criticality 106 can be indicated at various predetermined levels. In some embodiments, trigger criticality 106 can be assigned to one of three predetermined levels. Trigger criticality 106 can be associated with a high level, a medium level, and a low level. Each level can be associated with an MRM strategy.

For example, a level of high criticality (sufficient for L2) can be associated with an MRM strategy in which the vehicle has to stop immediately due to an inability to sense, plan, or control lateral motion to perform a lane change to another operating lane or road shoulder. The vehicle is assumed to be capable of staying in lane based on current or prior knowledge.

For example, a level of medium criticality (desired for L3, sufficient for L4) can be associated with an MRM strategy in which the vehicle can continue driving for a selected limited amount time (e.g., 90 s, 20 s, 15 s, etc.), is able to safely manage a lane change to the outer lanes if necessary, and then pull over to a shoulder if available. In contrast to the level of high criticality in which the vehicle must stop immediately, the MRM strategy associated with the level of medium criticality can permit the passage of a selected limited amount of time. If, after a timeout, the shoulder lane is not available, the vehicle has to stop in the outer lane. In some instances, there may be more than one level of medium criticality based on a time threshold. For example, various levels of medium criticality can be associated with allowing the vehicle to continue driving for the selected limited amount of time minus a predetermined time interval (e.g., 10 s, 40 s, 60 s, etc.). As used herein, an outer lane can refer to the right-most lane or slowest lane of a road, which is not a shoulder, and an inner lane can refer to a lane of the road that is not the outer lane (e.g., left-most lane).

For example, a level of low criticality (desired for L4) can be associated with an MRM strategy in which the vehicle can perform lane changes to outer lanes, and continue at a possibly lower speed in the outer lane for a selected extended amount of time. In contrast to the level of medium criticality in which the passage of the selected limited amount of time is permitted, the MRM strategy associated with the level of low criticality can permit the passage of the selected extended amount of time which can be longer than the selected limited amount of time. If an off-ramp is available, the vehicle can take the off-ramp, and pull over to the shoulder of the off-ramp if possible or stop to the side of the off-ramp lane.

In other examples, trigger criticality 106 can be associated with different levels of criticality and different associated MRM strategies.

Determination of trigger criticality 106 by the fault management system 100 can be based on one or more trigger conditions associated with a trigger event 102 as well as the status of any degraded features relating to vehicle operation. For example, assume a trigger event 102 associated with a trigger condition relating to vehicle capabilities where the left blinker of the vehicle is determined to be not functional. In this example, assume further that all of the features relating to vehicle operation, such as longitudinal control and lateral control, have a status of nominal. As a result, the fault management system 100 can determine that the trigger criticality for the trigger event 102 is at a low level. As another example, assume a trigger event 102 associated with a trigger condition relating to vehicle capabilities where a front facing, redundant camera of the vehicle is determined to be out of sync. In this example, assume further that the features relating to vehicle operation, such as longitudinal control and lateral control, have a status of nominal or limited. As a result, the fault management system 100 can determine that the trigger criticality for the trigger event 102 is at a medium level. As yet another example, assume a trigger event 102 associated with a trigger condition relating to vehicle capabilities where a perception related computing system is determined to be experiencing a software bug. In this example, assume further that some of the features relating to vehicle operation, such as longitudinal control and lateral control, have a status of limited or not available. As a result, the fault management system 100 can determine that the trigger criticality for the trigger event 102 is at a high level. In some embodiments, trigger criticality 106 can be determined based on heuristics or rules-based algorithms.

Scenario conditions 108 along with trigger criticality 106 can inform the selection by the fault management system 100 of an appropriate MRM reaction 110.

Scenario conditions 108 can describe the state or circumstances in an environment of the vehicle to inform the feasibility, availability, or propriety of performing a particular MRM. Scenario conditions 108 can include, for example, the availability of a shoulder on a road travelled by the vehicle, the width of the shoulder, the state of traffic surrounding the vehicle, and the general visibility surrounding the vehicle. For example, assume that SIL and POTS are suitable or appropriate MRM reactions 110 for a particular trigger event 102 having an associated trigger criticality 106. Assume further that the fault management system 100 has determined that a shoulder adjacent to an outer lane in which the vehicle is travelling has a longitudinal length that is less than a threshold shoulder length value that indicates the availability of a shoulder for POTS. As a result, the fault management system 100 can determine that, because the shoulder is not available for POTS, the MRM to be performed should not be POTS but rather SIL. As another example, assume that POTS and PTORS are suitable or appropriate MRM reactions 110 for a particular trigger event 102 having an associated trigger criticality 106. Assume further that the fault management system 100 has determined that the conditions of traffic surrounding the vehicle travelling in a lane adjacent to the outer lane can permit the vehicle to safely change lanes to the outer lane and stop in an adjacent off-ramp shoulder. As a result, the fault management system 100 can determine that, because conditions of surrounding traffic are permissive, the MRM to be performed can be PTORS. The foregoing are merely examples illustrating consideration by the fault management system 100 of scenario conditions 108 in determination of MRM reactions 110. As illustrated for purposes of simplification, the MRM reactions 110 can include POTS, SIL, and PTORS. In some embodiments, the MRM reactions 110 also can include, for example, drive to next exit, pull over to left shoulder, pull over to off ramp, and the like. In some embodiments, the MRM reactions 110 can be any one or combination of MRMs.

Vehicles (or subject vehicles) as discussed herein can include any type of vehicles, such as passenger cars, vans, buses, trucks, motorcycles, mopeds, emergency vehicles, bicycles, scooters, and the like. The vehicles can include vehicles operable at various levels of autonomy or assistance (e.g., autonomous vehicles) as well as vehicles that are fully manually driven without any level of autonomy or assistance. As referenced herein, autonomous vehicles can include, for example, a fully autonomous vehicle, a partially autonomous vehicle, a vehicle with driver assistance, or an autonomous capable vehicle. The capabilities of autonomous vehicles can be associated with a classification system or taxonomy having tiered levels of autonomy. A classification system can be specified by, for example, industry standards or governmental guidelines. For example, based on the Society of Automotive Engineers (SAE) standard, the levels of autonomy can be considered using a taxonomy such as level 0 (momentary driver assistance), level 1 (driver assistance), level 2 (additional assistance), level 3 (conditional assistance), level 4 (high automation), and level 5 (full automation without any driver intervention). Following this example, an autonomous vehicle can be capable of operating, in some instances, in at least one of levels 0 through 5. According to various embodiments, an autonomous capable vehicle may refer to a vehicle that can be operated by a driver manually (that is, without the autonomous capability activated) while being capable of operating in at least one of levels 0 through 5 upon activation of an autonomous mode. As used herein, the term “driver” may refer to a local operator (e.g., an operator in the vehicle) or a remote operator (e.g., an operator physically remote from and not in the vehicle). The autonomous vehicle may operate solely at a given level (e.g., level 2 additional assistance or level 5 full automation) for at least a period of time or during the entire operating time of the autonomous vehicle. Other classification systems can provide other levels of autonomy characterized by different vehicle capabilities.

A road as discussed herein can be a road of any type. The road can be a highway, freeway, expressway, street, roadway, or the like in a metropolitan, urban, suburban, rural, or industrial environment. The road 102 can be of any length, such as 1 kilometer, 1 mile, 5 kilometers, 5 miles, 40 kilometers, 35 miles, etc. Portions of the road can reflect any one or a combination of geometries, such as substantially straight, curved, windy, etc. Portions of the road can be substantially flat, uphill, or downhill. The road can support one way traffic or two way traffic. For each direction of traffic supported by the road, the road can have any number of lanes, such as one lane, two lanes, three lanes, four lanes, five lanes, etc. Depending on the particular road, the lanes of the road can include, for example, basic lanes, shoulders, carpool lanes, emergency lanes, merge lanes, on ramps, off ramps, off ramps shoulders, on ramp shoulders, etc.

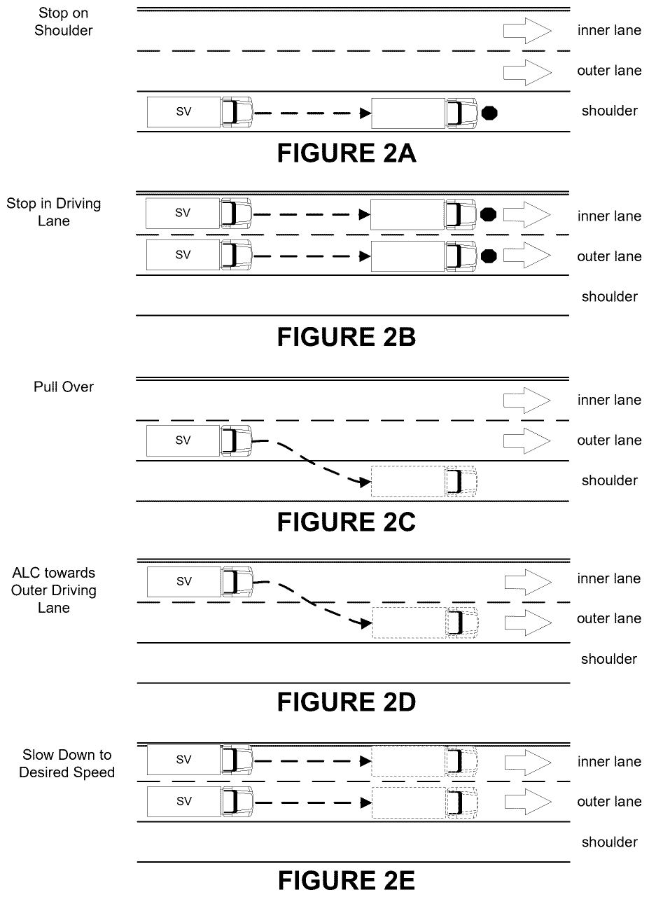

FIGS. 2A-2E illustrate example atomic maneuvers, according to some embodiments of the present technology. The atomic maneuvers can be used to create functional scenarios that describe road topography, initial conditions, and vehicle maneuvers including MRMs. The atomic maneuvers can be utilized to build up functional scenarios for different trigger conditions. In FIG. 2A, an atomic maneuver associated with “stop on shoulder” (i.e., “atomic maneuver A”) involves a subject vehicle travelling on a shoulder of a road and stopping on the shoulder. In FIG. 2B, an atomic maneuver associated with “stop in driving lane” (i.e., “atomic maneuver B”) involves a subject vehicle travelling in a lane (e.g., inner lane, outer lane, etc.) of a road and stopping in the lane. In FIG. 2C, an atomic maneuver associated with “pull over” (i.e., “atomic maneuver C”) involves a subject vehicle travelling in an outer lane (e.g., slow lane) of a road, moving to a shoulder of a road, and travelling on the shoulder. In FIG. 2D, an atomic maneuver associated with “automatic lane change (ALC) towards outer driving lane” (i.e., “atomic maneuver D”) involves a subject vehicle travelling in an inner lane (e.g., fast lane) of a road, moving to an outer lane, and travelling in the outer lane. In FIG. 2E, an atomic maneuver associated with “slow down to desired speed” (i.e., “atomic maneuver E”) involves a subject vehicle travelling in a lane of a road and reducing speed to a desired speed in the lane. The desired speed can be any suitable selected speed (e.g., 20 meters per second, etc.). The foregoing are examples of atomic maneuvers and other atomic maneuvers are possible.

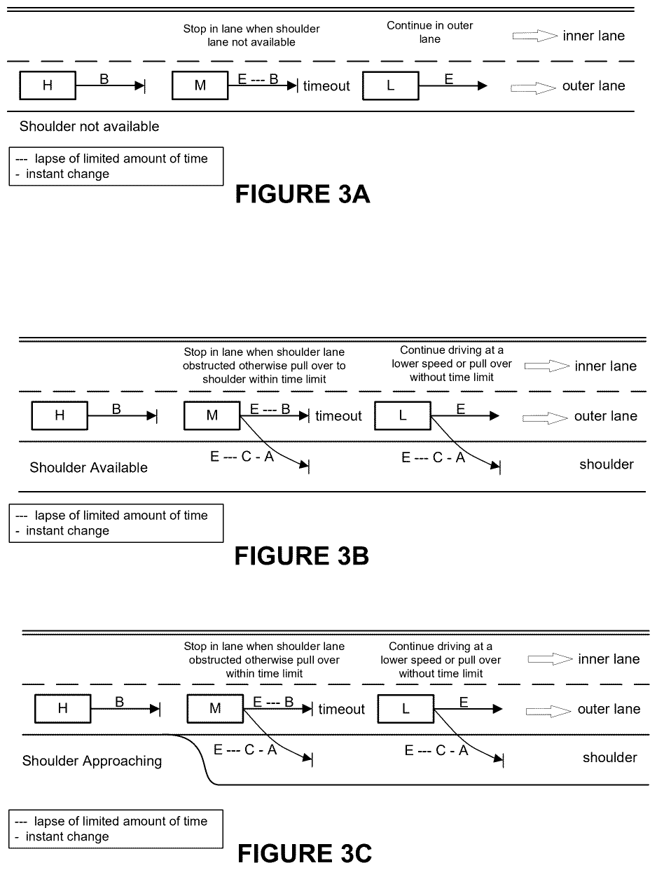

FIGS. 3A-3C illustrate example functional scenarios associated with no automatic lane change (ALC), according to some embodiments of the present technology. In FIG. 3A, a subject vehicle is travelling in an outer lane of a road where a shoulder is not available. When a trigger event with high trigger criticality (“H”) occurs, the subject vehicle can perform atomic maneuver B. When a trigger event with medium trigger criticality (“M”) occurs, the subject vehicle can perform atomic maneuver E, continue at the desired speed for a limited amount of time (e.g., 15 s, 20 s, etc.), and perform atomic maneuver B before lapse of the limited amount of time. When a trigger event with low trigger criticality (“L”) occurs, the subject vehicle can perform atomic maneuver E.

In FIG. 3B, a subject vehicle is initially travelling in an outer lane of a road where a shoulder (or shoulder lane) is available. When a trigger event with high trigger criticality (“H”) occurs, the subject vehicle can perform atomic maneuver B. When a trigger event with medium trigger criticality (“M”) occurs, and when the shoulder is obstructed, the subject vehicle can perform atomic maneuver E, continue at the desired speed for a limited amount of time, and perform atomic maneuver B before lapse of the limited amount of time. Alternatively, when the shoulder is not obstructed, the subject vehicle can perform atomic maneuver E, continue at the desired speed for a limited amount of time, perform atomic maneuver C, and perform atomic maneuver A before lapse of the limited amount of time. When a trigger event with low trigger criticality (“L”) occurs, the subject vehicle can perform atomic maneuver E. Alternatively, the subject vehicle can perform atomic maneuver E, continue at the desired speed for a limited amount of time, perform atomic maneuver C, and perform atomic maneuver A without time limit.

In FIG. 3C, a subject vehicle is initially travelling in an outer lane of a road where a shoulder (or shoulder lane) is approaching. When a trigger event with high trigger criticality (“H”) occurs, the subject vehicle can perform atomic maneuver B. When a trigger event with medium trigger criticality (“M”) occurs, and when the shoulder is obstructed, the subject vehicle can perform atomic maneuver E, continue at the desired speed for a limited amount of time, and perform atomic maneuver B before lapse of the limited amount of time. Alternatively, when the shoulder is not obstructed, the subject vehicle can perform atomic maneuver E, continue at the desired speed for a limited amount of time, perform atomic maneuver C, and perform atomic maneuver A before lapse of the limited amount of time. When a trigger event with low trigger criticality (“L”) occurs, the subject vehicle can perform atomic maneuver E. Alternatively, the subject vehicle can perform atomic maneuver E, continue at the desired speed for a limited amount of time, perform atomic maneuver C, and perform atomic maneuver A without time limit. The described functional scenarios and associated atomic maneuvers are only examples and many variations are possible.

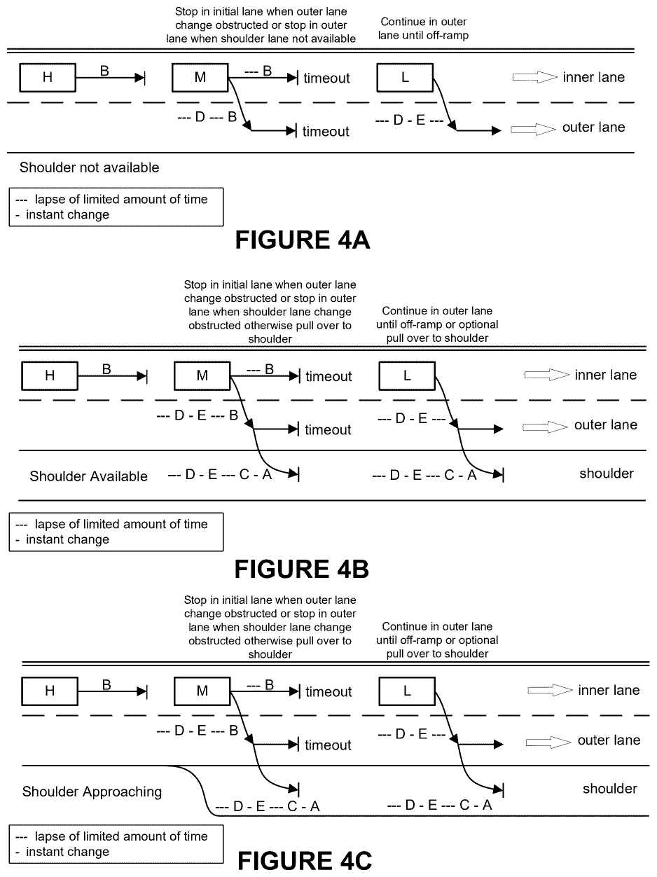

FIGS. 4A-4C illustrate example functional scenarios associated with automatic lane change (ALC), according to some embodiments of the present technology. In FIGS. 4A-4C, a subject vehicle does not initially travel in an outer lane, and thus needs to perform a lane change to reach the outer lane before stopping in lane or pulling over. In FIG. 4A, a subject vehicle is initially travelling in an inner lane of a road where a shoulder (or shoulder lane) is not available. When a trigger event with high trigger criticality (“H”) occurs, the subject vehicle can perform atomic maneuver B. When a trigger event with medium trigger criticality (“M”) occurs, and when the outer lane is obstructed, the subject vehicle can continue for a limited amount of time and perform atomic maneuver B before lapse of the limited amount of time. Alternatively, when the outer lane is not obstructed, the subject vehicle can continue for a limited amount of time, perform atomic maneuver D, continue for a second limited amount of time, and perform atomic maneuver B before lapse of the second limited amount of time. When a trigger event with low trigger criticality (“L”) occurs, the subject vehicle can continue for a limited amount of time, perform atomic maneuver D, perform atomic maneuver E, and continue at the desired speed until an off ramp.

In FIG. 4B, a subject vehicle is initially travelling in an inner lane of a road where a shoulder (or shoulder lane) is available. When a trigger event with high trigger criticality (“H”) occurs, the subject vehicle can perform atomic maneuver B. When a trigger event with medium trigger criticality (“M”) occurs, and when the outer lane is obstructed, the subject vehicle can continue for a limited amount of time and perform atomic maneuver B before lapse of the limited amount of time. Alternatively, when the outer lane is not obstructed, and when the shoulder is obstructed, the subject vehicle can continue for a limited amount of time, perform atomic maneuver D, perform atomic maneuver E, continue at the desired speed for a second limited amount of time, and perform atomic maneuver B before lapse of the second limited amount of time. Alternatively, after the subject vehicle has entered the outer lane, and when the shoulder is not obstructed, the subject vehicle can continue for a limited amount of time, perform atomic maneuver D, perform atomic maneuver E, continue at the desired speed for a second limited amount of time, perform atomic maneuver C, and perform atomic maneuver A. When a trigger event with low trigger criticality (“L”) occurs, the subject vehicle can continue for a limited amount of time, perform atomic maneuver D, perform atomic maneuver E, and continue at the desired speed until an off ramp. Alternatively, when the shoulder is not obstructed, the subject vehicle can continue for a limited amount of time, perform atomic maneuver D, perform atomic maneuver E, continue at the desired speed for a second limited amount of time in the outer lane, perform atomic maneuver C, and perform atomic maneuver A.

In FIG. 4C, a subject vehicle is initially travelling in an inner lane of a road where a shoulder (or shoulder lane) is approaching. When a trigger event with high trigger criticality (“H”) occurs, the subject vehicle can perform atomic maneuver B. When a trigger event with medium trigger criticality (“M”) occurs, and when the outer lane is obstructed, the subject vehicle can continue for a limited amount of time and perform atomic maneuver B before lapse of the limited amount of time. Alternatively, when the outer lane is not obstructed, and when the shoulder is obstructed, the subject vehicle can continue for a limited amount of time, perform atomic maneuver D, perform atomic maneuver E, continue at the desired speed for a second limited amount of time, and perform atomic maneuver B before lapse of the second limited amount of time. Alternatively, after the subject vehicle has entered the outer lane, and when the shoulder is not obstructed, the subject vehicle can continue for a limited amount of time, perform atomic maneuver D, perform atomic maneuver E, continue at the desired speed for a second limited amount of time, perform atomic maneuver C, and perform atomic maneuver A. When a trigger event with low trigger criticality (“L”) occurs, the subject vehicle can continue for a limited amount of time, perform atomic maneuver D, perform atomic maneuver E, and continue at the desired speed until an off ramp. Alternatively, when the shoulder is not obstructed, the subject vehicle can continue for a limited amount of time, perform atomic maneuver D, perform atomic maneuver E, continue at the desired speed for a second limited amount of time in the outer lane, perform atomic maneuver C, and perform atomic maneuver A. As stated, the described functional scenarios and associated atomic maneuvers are only examples and many variations are possible.

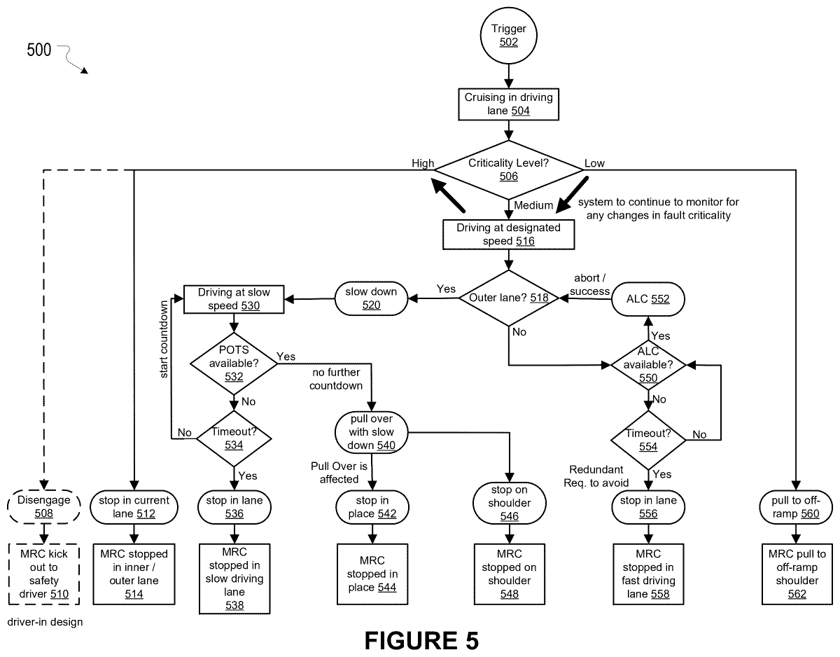

FIG. 5 illustrates example decision logic 500 for a fault management system, according to some embodiments of the present technology. In some embodiments, the decision logic 500 can be implemented by the fault management system 100. The decision logic 500 can reflect decision-making that links trigger conditions to response strategies as described in functional scenarios. At 502, a trigger (or trigger event) associated with a vehicle (or subject vehicle) can be detected. At 504, the vehicle can be cruising in a driving lane. At 506, a criticality level (or trigger criticality) can be determined. If the criticality level is high, at 508, an autonomous or automatic navigation system of the vehicle can be disengaged and, at 510, the vehicle can transition to a minimal risk condition (MRC) (e.g., stopped state) and can pass control of the vehicle to a present safety driver. Alternatively, if the criticality level is high, at 512, the vehicle can stop in the current lane (e.g., an inner lane, outer lane) and, at 514, an MRC can exist in the current lane.

If the criticality level is medium, at 516, the vehicle can be driving at a designated speed. At 518, it can be determined whether the vehicle is driving in the outer lane. If the vehicle is driving in the outer lane, at 520, the vehicle can slow down. At 530, the vehicle can be driving at a slow speed. For example, the slow speed can be any suitable speed (e.g., 20 m/s) to enable subsequent pull over to shoulder. At 532, it can be determined whether POTS is available. The availability of POTS can be based on a variety of considerations, such as shoulder length, shoulder width, shoulder surface condition, obstructions to shoulder, and the like. The determination of whether POTS is available can be conducted over a selected period of time. If POTS is not available, at 534, it can be determined whether a timeout condition has occurred, i.e., whether the selected period of time has elapsed. If the timeout condition has occurred, at 536, the vehicle can stop in lane and, at 538, an MRC can exist in the outer lane (or slow driving lane). If the timeout condition has not occurred, at 530, the vehicle can be driving at slow speed. If POTS is available, at 540, the vehicle can pull over with slow down. A pull over can be unadvisable or otherwise affected under certain circumstances, such as the presence of an obstructing object. If the pull over is affected, at 542, the vehicle can stop in place and, at 544, an MRC can exist. If the pull over is not affected, at 546, the vehicle can stop on the shoulder and, at 548, an MRC can exist on the shoulder.

If the vehicle is not driving in the outer lane, at 550, it can be determined whether ALC is available. The availability of ALC can be based on a variety of considerations, such as sufficient space in the lane to be entered, obstacles in the lane, speed of obstacles in the lane, and the like. If ALC is available, at 552, the vehicle can perform ALC and, at 518, it can be determined whether the vehicle is driving in the outer lane. In some instances, multiple lane changes can be performed until the vehicle reaches the outer lane. If ALC is not available, at 554, it can be determined whether a timeout condition has occurred, i.e., whether a selected period of time has elapsed. If the timeout condition has not occurred, at 550, it can be determined whether ALC is available. If the timeout condition has occurred, at 556, the vehicle can stop in lane and, at 558, an MRC can exist in an inner lane (or fast-driving lane).

If the criticality level is low, at 560, the vehicle can pull over to off ramp and, at 562, an MRC can exist on the off-ramp shoulder.

Many variations to the example decision logic 500 are possible. It should be appreciated that there can be additional, fewer, or alternative steps performed in similar or alternative orders, or in parallel, within the scope of the various embodiments discussed herein.

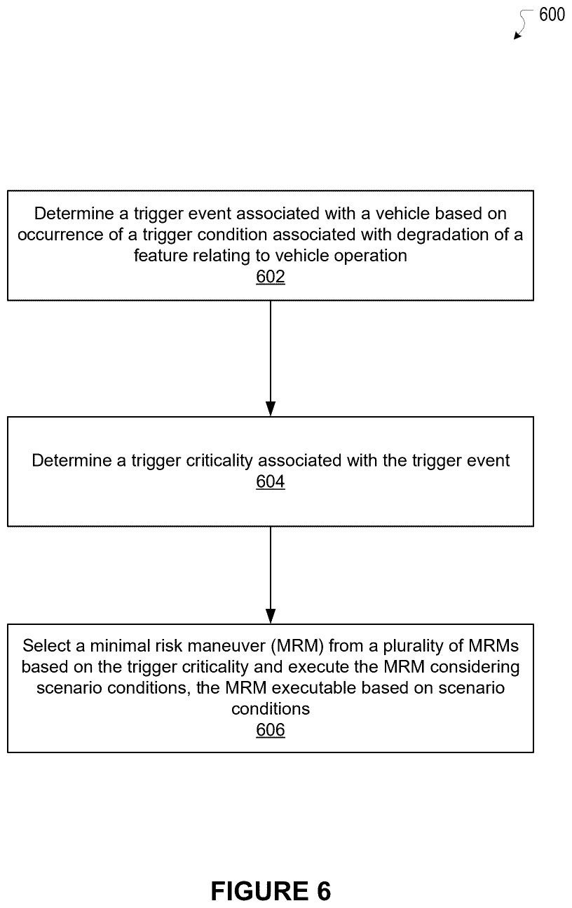

FIG. 6 illustrates an example method 600, according to embodiments of the present technology. At block 602, the method 600 can determine a trigger event associated with a vehicle based on occurrence of a trigger condition associated with degradation of a feature relating to vehicle operation. At block 604, the method 600 can determine a trigger criticality associated with the trigger event. At block 606, the method 600 can select a minimal risk maneuver (MRM) from a plurality of MRMs based on the trigger criticality, the MRM executable based on scenario conditions. Many variations to the example method are possible. It should be appreciated that there can be additional, fewer, or alternative steps performed in similar or alternative orders, or in parallel, within the scope of the various embodiments discussed herein unless otherwise stated.

It is contemplated that there can be many other uses, applications, and/or variations associated with the various embodiments of the present technology. In some embodiments, machine learning based techniques can be implemented in the present technology. In some embodiments, trigger criticality 106 can be determined by a machine learning technique. A machine learning model (e.g., neural network) can be trained with suitable training data. For example, an example of training data can be associated with a type of trigger condition related to vehicle capabilities or non-vehicle capabilities. The example of training data can include features relating to vehicle operation and their associated status. The status can include an indication regarding whether features relating to vehicle operation are degraded. The example of training data further can include a designation of trigger criticality for the trigger event 102 associated with the features relating to vehicle operation and their corresponding status. The designation of trigger criticality in the example of training data can specify a level of a predetermined number of levels indicating severity of the trigger event. In some embodiments, the training data can be based on or derived from historical driving records that include data describing the status and condition of a vehicle in relation to a trigger event 102 that has occurred. The designation of trigger criticality in the training data can be based on the consequences or outcome of the trigger event 102 that occurred and the impact of the trigger event 102 on the safety of occupants in the vehicle or persons in the environment of the vehicle. In some embodiments, the training data can be based on or derived from computer generated simulations of the occurrence of a trigger event. A computer generated simulation can involve data describing the status and condition of a vehicle in relation to a simulated trigger event. The designation of trigger criticality in the training data can be based on the predicted impact of the trigger event 102 on the safety of occupants in the vehicle or persons in the environment of the vehicle. The predicted impact can be based on appropriate behavior modeling of the vehicle and obstacles in the environment.

In some embodiments, an MRM reaction 110 can be determined by a machine learning technique. A machine learning model (e.g., neural network) can be trained with suitable training data to determine a suitable MRM. For example, an example of training data can include data regarding scenario conditions and trigger criticality associated with a trigger event. The example of training data further can include one or more MRMs appropriate for the scenario conditions and trigger criticality. The training data can reflect different MRMs based on different trigger criticalities and can reflect different MRMs based on different scenario conditions for a given trigger criticality. In some embodiments, the training data can be based on or derived from historical driving records that include data describing the safety status of persons in a vehicle and surrounding environment in relation to performance of a particular MRM. In some embodiments, the training data can be based on or derived from computer generated simulations of predicted outcomes resulting from performance of a particular MRM in response to given trigger criticality and scenario conditions. The predicted outcomes can be based on appropriate behavior modeling of the vehicle and obstacles in the environment. The foregoing examples relating to machine learning techniques are merely examples. Many variations are possible. Various embodiments of the present technology can learn, improve, and/or be refined over time.

FIG. 7 illustrates an example vehicle 700, such as the vehicle or subject vehicle discussed herein, including a system 710, according to various embodiments of the present technology. The system 710 can be or include an autonomous, automated, or assistance system. The functionality and operation of the present technology, including the system 710, can be implemented in whole or in part by the vehicle 700. The present technology can cause desired control and navigation of the vehicle 700, as described herein. In some embodiments, the vehicle 700 is a passenger vehicle, light commercial vehicle, truck (which can include a trailer), or any other type of motorized transport. The truck can be of any size (e.g., medium truck, heavy truck, very heavy truck, etc.) or weight (e.g., greater than 14,000 pounds, greater than 26,000 pounds, greater than 70,000 pounds, etc.). The system 710 of the vehicle 700 can support and execute various modes of operation or navigation of the vehicle 700. The system 710 can support and execute one or more of various operational or navigational modes, such as an autonomous driving mode, a semi-autonomous driving mode, a driver assisted driving mode, or the like. The system 710 also can enable a manual driving mode. For operation of the vehicle 700, the system 710 can execute or enable one or more of the autonomous driving mode, the semi-autonomous driving mode, the driver assisted driving mode, and the manual driving mode, and selectively transition among the driving modes based on a variety of factors, such as operating conditions, vehicle capabilities, and driver preferences.

In some embodiments, the system 710 can include, for example, a perception module 712, a localization module 714, a prediction and planning module 716, and a control module 718. The functionality of the perception module 712, the localization module 714, the prediction and planning module 716, and the control module 718 of the system 710 are described in brief for purposes of illustration. As mentioned, the components (e.g., modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the system 710 can be implemented in any suitable combinations.

The perception module 712 can receive and analyze various types of data about an environment in which the vehicle 700 is located. Through analysis of the various types of data, the perception module 712 can perceive the environment of the vehicle 700 and provide the vehicle 700 with critical information so that planning of navigation of the vehicle 700 is safe and effective. For example, the perception module 712 can determine the pose, trajectories, size, shape, and type of obstacles in the environment of the vehicle 700. Various models, such as machine learning models, can be utilized in such determinations.

The various types of data received by the perception module 712 can be any data that is supportive of the functionality and operation of the present technology. For example, the data can be attributes of the vehicle 700, such as location, velocity, acceleration, weight, and height of the vehicle 700. As another example, the data can relate to topographical features in the environment of the vehicle 700, such as traffic lights, road signs, lane markers, landmarks, buildings, structures, trees, curbs, bodies of water, etc. As yet another example, the data can be attributes of dynamic obstacles in the surroundings of the vehicle 700, such as location, velocity, acceleration, size, type, and movement of vehicles, persons, animals, road hazards, etc.

Sensors can be utilized to capture the data. The sensors can include, for example, cameras, radar, LiDAR (light detection and ranging), GPS (global positioning system), IMUs (inertial measurement units), and sonar. The sensors can be appropriately positioned at various locations (e.g., front, back, sides, top, bottom) on or in the vehicle 700 to optimize the collection of data. The data also can be captured by sensors that are not mounted on or in the vehicle 700, such as data captured by another vehicle (e.g., another truck) or by non-vehicular sensors located in the environment of the vehicle 700.

The localization module 714 can determine the pose of the vehicle 700. Pose of the vehicle 700 can be determined in relation to a map of an environment in which the vehicle 700 is travelling. Based on data received by the vehicle 700, the localization module 714 can determine distances and directions of features in the environment of the vehicle 700. The localization module 714 can compare features detected in the data with features in a map (e.g., HD map) to determine the pose of the vehicle 700 in relation to the map. The features in the map can include, for example, traffic lights, crosswalks, road signs, lanes, road connections, stop lines, etc. The localization module 714 can allow the vehicle 700 to determine its location with a high level of precision that supports optimal navigation of the vehicle 700 through the environment.

The prediction and planning module 716 can plan motion of the vehicle 700 from a start location to a destination location. The prediction and planning module 716 can generate a route plan, which reflects high level objectives, such as selection of different roads to travel from the start location to the destination location. The prediction and planning module 716 also can generate a behavioral plan with more local focus. For example, a behavioral plan can relate to various actions, such as changing lanes, merging onto an exit lane, turning left, passing another vehicle, etc. In addition, the prediction and planning module 716 can generate a motion plan for the vehicle 800 that navigates the vehicle 700 in relation to the predicted location and movement of other obstacles so that collisions are avoided. The prediction and planning module 716 can perform its planning operations subject to certain constraints. The constraints can be, for example, to ensure safety, to minimize costs, and to enhance comfort. In some embodiments, an infrastructure system that services a road on which the vehicle 700 is travelling can generate or determine various types of data, such as data relating to objects and events in a segment of the road in which the vehicle 700 is positioned. For example, the data relating to objects can include classification, position, heading, speed, predicted behavior, and other attributes of objects. To enhance safety and navigation of the vehicle 700, the data generated or determined by the infrastructure system can be provided to the vehicle 700 to supplement or replace data generated or determined by the perception module 712, the localization module 714, and the prediction and planning module 716 of the vehicle 700.

Based on output from the prediction and planning module 716, the control module 718 can generate control signals that can be communicated to different parts of the vehicle 700 to implement planned vehicle movement. The control module 718 can provide control signals as commands to actuator subsystems of the vehicle 700 to generate desired movement. The actuator subsystems can perform various functions of the vehicle 700, such as braking, acceleration, steering, signaling, etc.

The system 710 can include a data store 720. The data store 720 can be configured to store and maintain information that supports and enables operation of the vehicle 700 and functionality of the system 710. The information can include, for example, instructions to perform the functionality of the system 710, data captured by sensors, data received from a remote computing system, parameter values reflecting vehicle states, map data, machine learning models, algorithms, vehicle operation rules and constraints, navigation plans, etc.

The system 710 of the vehicle 700 can communicate over a communications network with other computing systems to support navigation of the vehicle 700. The communications network can be any suitable network (e.g., wireless, over the air, wired, etc.) through which data can be transferred between computing systems. Communications over the communications network involving the vehicle 700 can be performed in real time (or near real time) to support navigation of the vehicle 700.

The system 710 can communicate with a remote computing system (e.g., server, server farm, peer computing system) over the communications network. The remote computing system can include an autonomous, automated, or assistance system and perform some or all of the functionality of the system 710. In some embodiments, the functionality of the system 710 can be distributed between the vehicle 700 and the remote computing system to support navigation of the vehicle 700. For example, some functionality of the system 710 can be performed by the remote computing system and other functionality of the system 710 can be performed by the vehicle 700. In some embodiments, a fleet of vehicles including the vehicle 700 can communicate data captured by the fleet to a remote computing system controlled by a provider of fleet management services. The remote computing system in turn can aggregate and process the data captured by the fleet. The processed data can be selectively communicated to the fleet, including vehicle 700, to assist in navigation of the fleet as well as the vehicle 700 in particular. In some embodiments, the system 710 of the vehicle 700 can directly communicate with a remote computing system of another vehicle. For example, data captured by the other vehicle can be provided to the vehicle 700 to support navigation of the vehicle 700, and vice versa. The vehicle 700 and the other vehicle can be owned by the same entity in some instances. In other instances, the vehicle 700 and the other vehicle can be owned by different entities.

In various embodiments, the functionalities described herein with respect to the present technology can be implemented, in part or in whole, as software, hardware, or any combination thereof. In some cases, the functionalities described with respect to the present technology can be implemented, in part or in whole, as software running on one or more computing devices or systems. In a further example, the functionalities described with respect to the present technology can be implemented using one or more computing devices or systems that include one or more servers, such as network servers or cloud servers. It should be understood that there can be many variations or other possibilities.

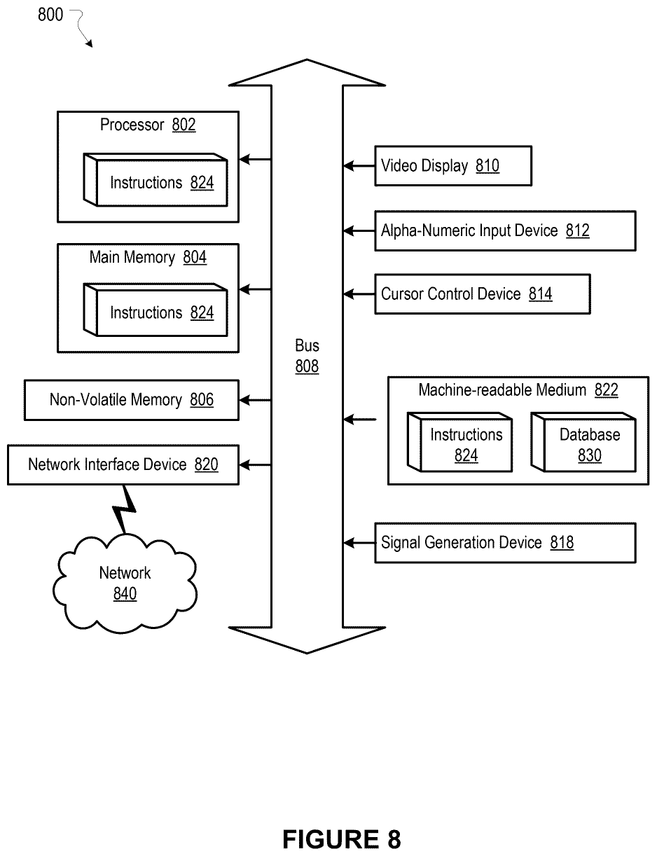

FIG. 8 illustrates an example computer system 800 that may be used to implement one or more of the embodiments of the present technology. The computer system 800 can be included in a wide variety of local and remote machine and computer system architectures and in a wide variety of network and computing environments that can implement the functionalities of the present technology. The computer system 800 includes sets of instructions 824 for causing the computer system 800 to perform the functionality, features, and operations discussed herein. The computer system 800 may be connected (e.g., networked) to other machines and/or computer systems. In a networked deployment, the computer system 800 may operate in the capacity of a server or a client machine in a client-server network environment, or as a peer machine in a peer-to-peer (or distributed) network environment. One or more features or components of the computer system 800 as described herein can be omitted in various embodiments.

The computer system 800 includes a processor 802 (e.g., a central processing unit (CPU), a graphics processing unit (GPU), or both), a main memory 804, and a nonvolatile memory 806 (e.g., volatile RAM and non-volatile RAM, respectively), which communicate with each other via a bus 808. In some embodiments, the computer system 800 can be a desktop computer, a laptop computer, personal digital assistant (PDA), or mobile phone, for example. In one embodiment, the computer system 800 also includes a video display 810, an alphanumeric input device 812 (e.g., a keyboard), a cursor control device 814 (e.g., a mouse), a signal generation device 818 (e.g., a speaker) and a network interface device 820.

In one embodiment, the video display 810 includes a touch sensitive screen for user input. In one embodiment, the touch sensitive screen is used instead of a keyboard and mouse. A machine-readable medium 822 can store one or more sets of instructions 824 (e.g., software) embodying any one or more of the methodologies, functions, or operations described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 830.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 806 may also be a random access memory. The non-volatile memory 806 can be a local device coupled directly to the rest of the components in the computer system 800. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 600 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine-or computer-readable media used to actually affect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in some embodiments,” “in various embodiments,” “in an example,” “in one implementation,” or the like means that a particular feature, design, structure, or characteristic described in connection with the embodiment is included in at least one embodiment of the technology. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the technology of the embodiments of the invention is intended to be illustrative, but not limiting, of the scope of the invention, which is set forth in the following claims.

1. A computer-implemented method comprising:
determining, by a computing system, a trigger event associated with a vehicle based on occurrence of a trigger condition associated with a feature relating to vehicle operation, wherein the trigger condition relates to an operational design domain (ODD) of the vehicle;
determining, by the computing system, a trigger criticality associated with the trigger event, wherein the trigger criticality is selected from a plurality of predetermined trigger criticality levels; and
selecting, by the computing system, a minimal risk maneuver (MRM) from a plurality of MRMs based on the trigger criticality, the MRM executable based on scenario conditions, wherein the plurality of MRMs comprise:
(a) for a first trigger criticality level, a first MRM associated with causing the vehicle to stop without permitting continued driving; and
(b) for a second trigger criticality level, a second MRM associated with
permitting the vehicle to continue driving for a selected limited time interval while evaluating the scenario conditions for availability of (i) an automatic lane change toward an outer driving lane and (ii) a shoulder pull-over, and
causing a stop-in-lane upon expiration of the limited time interval when the shoulder pull-over is not available.

2. The computer-implemented method of claim 1, wherein the trigger condition relates to base capabilities of the vehicle.

3. The computer-implemented method of claim 1, wherein the trigger condition relates to capabilities of the vehicle provided by an advanced driving system (ADS).

4. The computer-implemented method of claim 1, wherein the trigger condition relates to at least one of offboard infrastructure, or a state of a driver of the vehicle.

5. The computer-implemented method of claim 1, wherein the feature relating to vehicle operation is from a plurality of features relating to vehicle operation including longitudinal control and lateral control.

6. The computer-implemented method of claim 1, wherein the feature relating to vehicle operation is associated with a status indicating a level of degradation from a predetermined number of levels.

7. The computer-implemented method of claim 1, wherein the trigger criticality is associated with a level from a plurality of levels indicating severity of the trigger event.

8. The computer-implemented method of claim 1, wherein the MRM is associated with a functional scenario built from a plurality of atomic maneuvers including stop on shoulder, stop in driving lane, pull over, automatic lane change (ALC) towards outer driving lane, and slow down to desired speed.

9. The computer-implemented method of claim 8, wherein the functional scenario is from a set of functional scenarios associated with initial vehicle travel in an outer lane without ALC or a set of functional scenarios associated with initial vehicle travel not in the outer lane with ALC.

10. (canceled)

11. A system comprising:
at least one processor; and
a memory storing instructions that, when executed by the at least one processor, cause the system to perform operations comprising:
determining a trigger event associated with a vehicle based on occurrence of a trigger condition associated with a feature relating to vehicle operation, wherein the trigger condition relates to an operational design domain (ODD) of the vehicle;
determining a trigger criticality associated with the trigger event, wherein the trigger criticality is selected from a plurality of predetermined trigger criticality levels; and
selecting a minimal risk maneuver (MRM) from a plurality of MRMs based on the trigger criticality, the MRM executable based on scenario conditions, wherein the plurality of MRMs comprise:
(a) for a first trigger criticality level, a first MRM associated with causing the vehicle to stop without permitting continued driving; and
(b) for a second trigger criticality level, a second MRM associated with
permitting the vehicle to continue driving for a selected limited time interval while evaluating the scenario conditions for availability of (i) an automatic lane change toward an outer driving lane and (ii) a shoulder pull-over, and
causing a stop-in-lane upon expiration of the limited time interval when the shoulder pull-over is not available.

12. The system of claim 11, wherein the trigger condition relates to base capabilities of the vehicle.

13. The system of claim 11, wherein the trigger condition relates to capabilities of the vehicle provided by an advanced driving system (ADS).

14. The system of claim 11, wherein the trigger condition relates to at least one of offboard infrastructure, or a state of a driver of the vehicle.

15. The system of claim 11, wherein the feature relating to vehicle operation is from a plurality of features relating to vehicle operation including longitudinal control and lateral control.

16. A non-transitory computer-readable storage medium including instructions that, when executed by at least one processor of a computing system, cause the computing system to perform operations comprising:
determining a trigger event associated with a vehicle based on occurrence of a trigger condition associated with a feature relating to vehicle operation, wherein the trigger condition relates to an operational design domain (ODD) of the vehicle;
determining a trigger criticality associated with the trigger event, wherein the trigger criticality is selected from a plurality of predetermined trigger criticality levels; and
selecting a minimal risk maneuver (MRM) from a plurality of MRMs based on the trigger criticality, the MRM executable based on scenario conditions, wherein the plurality of MRMs comprise:
(a) for a first trigger criticality level, a first MRM associated with causing the vehicle to stop without permitting continued driving; and
(b) for a second trigger criticality level, a second MRM associated with
permitting the vehicle to continue driving for a selected limited time interval while evaluating the scenario conditions for availability of (i) an automatic lane change toward an outer driving lane and (ii) a shoulder pull-over, and
causing a stop-in-lane upon expiration of the limited time interval when the shoulder pull-over is not available.

17. The non-transitory computer-readable storage medium of claim 16, wherein the trigger condition relates to base capabilities of the vehicle.

18. The non-transitory computer-readable storage medium of claim 16, wherein the trigger condition relates to capabilities of the vehicle provided by an advanced driving system (ADS).

19. The non-transitory computer-readable storage medium of claim 16, wherein the trigger condition relates to offboard infrastructure, or a state of a driver of the vehicle.

20. The non-transitory computer-readable storage medium of claim 16, wherein the feature relating to vehicle operation is from a plurality of features relating to vehicle operation including longitudinal control and lateral control.

21. The computer-implemented method of claim 1, wherein the MRM is determined by a machine learning model trained based on training data, the training data derived from computer generated simulations of predicted outcomes resulting from behavior modeling of performance of MRMs in response to associated trigger criticality and scenario conditions.
